(19) United States
(12) Patent Application Publication
(10) Pub. No.: US 2007/0195014 A1
(43) Pub. Date: Aug. 23, 2007

(54) PLASMA DISPLAY APPARATUS AND METHOD OF DRIVING THE SAME

(76) Inventors: Seonghwan RYU, Gumi-si (KR); Kirack Park, Chilgok-gun (KR); Yoonjoo Cho, Seoul (KR); Dooyong Hwang, Yongin-si (KR); Jongwoon Bae, Gumi-si (KR)

Correspondence Address: KED & ASSOCIATES, LLP, P.O. Box 221200, Chantilly, VA, 20153-1200, US

(21) Appl. No.: 11/548,379

(22) Filed: Oct. 11, 2006

(30) Foreign Application Priority Data
Oct. 11, 2005 (KR) 10-2005-0095769

(51) Int. Cl. G09G 3/28

(52) U.S. Cl. 345/67

(57) ABSTRACT

A plasma display apparatus and a method of driving the same are disclosed. A scan driver of the plasma display apparatus supplies scan signals to scan electrodes using a first scan type in a first subfield of a frame, and supplies the scan signals to the scan electrodes using a second scan type, which supplies the scan signals in an order different from the first scan type, in a second subfield of the frame. The scan electrode or a sustain electrode includes a base formed in a direction of the scan electrode and the sustain electrode and a projecting portion. The projecting portion projects from the base toward a central direction of a discharge cell.

This Nonprovisional application claims priority under 35 U.S.C. §119(a) on Patent Application No. 10-2005-0095769 filed in Korea on Oct. 11, 2005 the entire contents of which are hereby incorporated by reference.

### BACKGROUND

1. Field

This document relates to a display apparatus, and more particularly, to a plasma display apparatus and a method of driving the same.

2. Description of the Related Art

A plasma display panel comprises a front panel, a rear panel and barrier ribs formed between the front panel and the rear panel. The barrier ribs forms unit discharge cell or discharge cells. Each of discharge cells is filled with an inert gas containing a main discharge gas such as neon (Ne), helium (He) and a mixture of Ne and He, and a small amount of xenon (Xe). When it is discharged by a high frequency voltage, the inert gas generates vacuum ultra-violet rays, which thereby cause a phosphor formed inside the discharge cell to emit light, thus displaying an image. Since the plasma display panel can be manufactured to be thin and light, it has attracted attention as a next generation display device.

A plurality of electrodes, for example, a scan electrode, a sustain electrode and a data electrode are formed in the plasma display panel. A driver supplies a predetermined driving voltage to the plurality of electrodes to generate a discharge such that an image is displayed. The driver for supplying the predetermined driving voltage to the plurality of electrodes of the plasma display panel is connected to the plurality of electrodes in the form of a driver integrated circuit (IC).

For example, a data driver IC is connected to the data electrode of the plasma display panel, and a scan driver IC is connected to the scan electrode of the plasma display panel.

When driving the plasma display panel, the displacement current flows in these driver ICs. A magnitude of the displacement current varies by various factors.

For example, a displacement current flowing in the data driver IC may increase or decrease depending on equivalence capacitance of the plasma display panel and the number of switching operations of the data driver IC.

In particular, when image data is a specific pattern where logical values 1 and 0 are repeatedly input, the displacement current flowing in the data driver IC excessively increases such that the data driver IC is electrically damaged.

### SUMMARY OF THE INVENTION

In one aspect, a plasma display apparatus comprises a plurality of scan electrodes, a plurality of sustain electrodes formed in parallel to the plurality of scan electrodes, a plurality of data electrodes formed to intersect the plurality of scan electrodes and the plurality of sustain electrodes, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying a data signal corresponding to the scan signals to the plurality of data electrodes during an address period, wherein the scan electrode or the sustain electrode comprises a base and a projecting portion at a location corresponding to the inside of the discharge cell, the base is formed in a direction of the scan electrode and the sustain electrode, and the projecting portion projects from the base toward a central direction of the discharge cell and comprises a first projecting area and a second projecting area, and a distance between the second projecting area and the base is more than a distance between the first projecting area and the base, and the width of the second projecting area is more than the width of the first projecting area.

In another aspect, a method of driving a plasma display apparatus comprising a plurality of scan electrodes, a plurality of sustain electrodes, and a plurality of data electrodes formed to intersect the plurality of scan electrodes and the plurality of sustain electrodes, the method comprises supplying scan signals to the plurality of scan electrodes using a first scan type in a first subfield of a frame, supplying the scan signals to the plurality of scan electrodes using a second scan type, which is different from the first scan type in an order of supplying the scan signals, in a second subfield of the frame, and supplying a data signal corresponding to the scan signals to the plurality of data electrodes during an address period, wherein the scan electrode or the sustain electrode comprises a base and a projecting portion at a location corresponding to the inside of the discharge cell, the base is formed in a direction of the scan electrode and the sustain electrode, and the projecting portion projects from the base toward a central direction of the discharge cell and comprises a first projecting area and a second projecting area, and a distance between the second projecting area and the base is more than a distance between the first projecting area and the base, and the width of the second projecting area is more than the width of the first projecting area.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates the configuration of a plasma display apparatus according to one embodiment;

FIG. 2 illustrates an example of the structure of a plasma display panel of the plasma display apparatus according to the embodiment;

FIG. 3 illustrates the structure of electrodes formed inside a discharge cell according to the embodiment;

FIG. 4 illustrates wall charges distributed inside one discharge cell having the electrode structure of FIG. 3 when generating a discharge;

FIGS. 5a to 5c illustrate another structure of the electrode formed inside one discharge cell;

FIGS. 6a to 6c illustrate still another structure of the electrodes formed inside one discharge cell with respect to a difference in the areas of the electrodes;

FIG. 7 illustrates an example of the method of driving the plasma display apparatus;

FIG. 8 illustrates an example of a driving waveform in accordance with the method of driving the plasma display apparatus;

FIGS. 9a and 9b illustrate various scan types which are different from one another in the order of supplying scan signals to a plurality of scan electrodes;

FIG. 10 illustrates a plurality of scan types, which are different from one other in the order of supplying scan signals to the plurality of scan electrodes.

FIG. 11 illustrates one example of a method for determining a scan type by block;

FIG. 12 illustrates another example of a method for determining a scan type relative to a threshold value of the number of switching operations of the data driver;

FIG. 13 illustrates another example of a method for supplying scan signals to the plurality of scan electrodes using a plurality of scan types which are different from one other in the order of supplying the scan signals to the scan electrodes; and

FIG. 14 illustrates one example of a method for determining a scan type in consideration of a subfield.

### DETAILED DESCRIPTION OF PREFERRED EMBODIMENTS

Preferred embodiments of the present invention will be described in a more detailed manner with reference to the drawings.

A plasma display apparatus comprises a plurality of scan electrodes, a plurality of sustain electrodes formed in parallel to the plurality of scan electrodes, a plurality of data electrodes formed to intersect the plurality of scan electrodes and the plurality of sustain electrodes, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying a data signal corresponding to the scan signals to the plurality of data electrodes during an address period, wherein the scan electrode or the sustain electrode comprises a base and a projecting portion at a location corresponding to the inside of the discharge cell, the base is formed in a direction of the scan electrode and the sustain electrode, and the projecting portion projects from the base toward a central direction of the discharge cell and comprises a first projecting area and a second projecting area, and a distance between the second projecting area and the base is more than a distance between the first projecting area and the base, and the width of the second projecting area is more than the width of the first projecting area.

The number of times of switching of the data driver with respect to the first scan type in the first subfield may be less than the number of times of switching of the data driver with respect to the second type in the first subfield.

The number of switching operations of the data driver may equal the number of changes in a voltage level of the data signal.

At least one of the first scan type and the second scan type may comprise a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

The plurality of scan electrodes may comprise a first scan electrode, a second electrode, and a third electrode, adjacent to one another, to which the scan signals are supplied in a consecutive order. A distance between the first scan electrode and the second electrode may be substantially equal to a distance between the second scan electrode and the third electrode.

The scan driver may supply the scan signals to the scan electrodes using one of the first scan type and the second scan type, in which the number of times of switching of the data driver is less than the other, in response to a pattern of image data input for each subfield of the frame.

At least one of the first scan type and the second scan type may comprise a scan type for consecutively supplying the scan signals to the scan electrodes of one scan electrode group.

The scan driver may supply the scan signals to the plurality of scan electrodes using at least one of the first scan type and the second scan type, in which the number of switching operations of the data driver in response to a pattern of input image data is equal to or less than a threshold value.

When the number of switching operations of the data driver with respect to the first scan type in response to a pattern of input image data is equal to or more than a threshold value, the scan driver may supply the scan signals to the scan electrode using the second scan type.

The first scan type may comprise a scan type for consecutively supplying the scan signals to the plurality of scan electrodes. The scan driver may supply the scan signals to the scan electrodes using the first scan type when the number of switching operations of the data driver with respect to the first scan type in response to a pattern of input image data is equal to or less than a threshold value, and the scan driver may supply the scan signals to the scan electrodes using the second scan type when the number of switching operations of the data driver with respect to the first scan type in response to a pattern of input image data is equal to or more than a threshold value.

The width of at least one of the scan electrode or the sustain electrode in the direction of the scan electrode or the sustain electrode may gradually widen toward the central direction of the discharge cell.

The width of at least one of the scan electrode or the sustain electrode in the direction of the scan electrode or the sustain electrode may increase stepwise toward the central direction of the discharge cell.

At least one of the scan electrode or the sustain electrode may have a T shape.

At least one of the scan electrode or the sustain electrode may have a trapezoid shape.

The area of the scan electrode may be more than the area of the sustain electrode.

The overlap area of the scan electrode and the data electrode may be more than the overlap area of the sustain electrode and the data electrode at a location corresponding to the inside of the discharge cell.

A method of driving a plasma display apparatus comprising a plurality of scan electrodes, a plurality of sustain electrodes, and a plurality of data electrodes formed to intersect the plurality of scan electrodes and the plurality of sustain electrodes, the method comprises supplying scan signals to the plurality of scan electrodes using a first scan type in a first subfield of a frame, supplying the scan signals to the plurality of scan electrodes using a second scan type, which is different from the first scan type in an order of supplying the scan signals, in a second subfield of the frame, and supplying a data signal corresponding to the scan signals to the plurality of data electrodes during an address period, wherein the scan electrode or the sustain electrode comprises a base and a projecting portion at a location corresponding to the inside of the discharge cell, the base is formed in a direction of the scan electrode and the sustain electrode, and the projecting portion projects from the base toward a central direction of the discharge cell and comprises a first projecting area and a second projecting area, and a distance between the second projecting area and the base is more than a distance between the first projecting area and the base, and the width of the second projecting area is more than the width of the first projecting area.

The number of times of switching of the data driver with respect to the first scan type in the first subfield may be less than the number of times of switching of the data driver with respect to the second type in the first subfield.

The number of switching operations of the data driver may equal the number of changes in a voltage level of the data signal.

The first scan type may be a scan type for consecutively supplying the scan signals to the plurality of scan electrodes. The scan driver may supply the scan signals to the scan electrodes using the first scan type when the number of switching operations of the data driver with respect to the first scan type in response to a pattern of input image data is equal to or less than a threshold value, and the scan driver may supply the scan signals to the scan electrodes using the second scan type when the number of switching operations of the data driver with respect to the first scan type in response to a pattern of input image data is equal to or more than a threshold value.

Hereinafter, exemplary embodiments of the present invention will be described in detail with reference to the attached drawings.

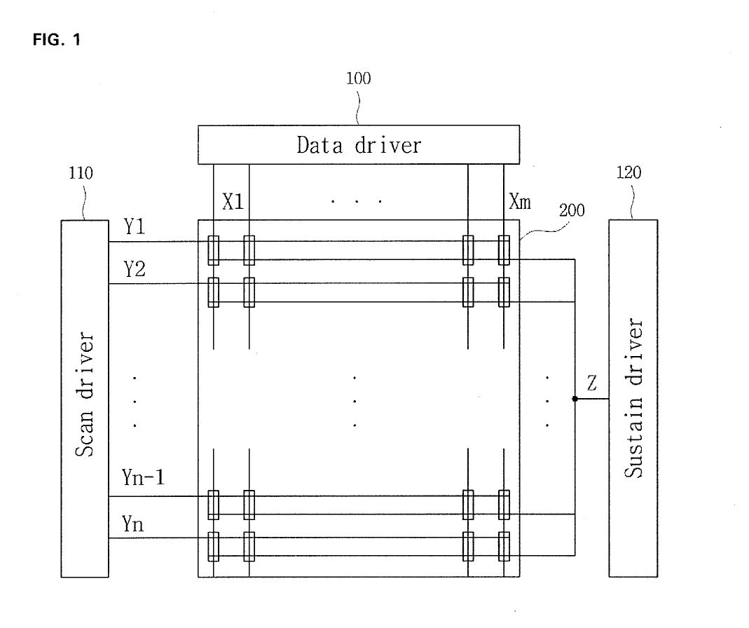

FIG. 1 illustrates the configuration of a plasma display apparatus according to one embodiment.

As illustrated in FIG. 1, the plasma display apparatus according to one embodiment comprises a plasma display panel 200, a data driver 100, a scan driver 110, and a sustain driver 120.

Although FIG. 1 illustrates the data driver 100, the scan driver 110 and the sustain driver 120 as being formed in different board shapes, respectively, at least two of the data driver 201, scan driver 202, and sustain driver 203 may be integrated in one board.

The plasma display panel 200 comprises a front panel (not illustrated) and a rear panel (not illustrated) which are coalesced with each other at a given distance. Further, the plasma display panel 200 comprises a plurality of electrodes, for example, scan electrodes Y1 to Yn, sustain electrodes Z formed in parallel to the scan electrodes Y1 to Yn, and data electrodes X1 to Xm formed to intersect the scan electrodes Y1 to Yn and the sustain electrodes Z.

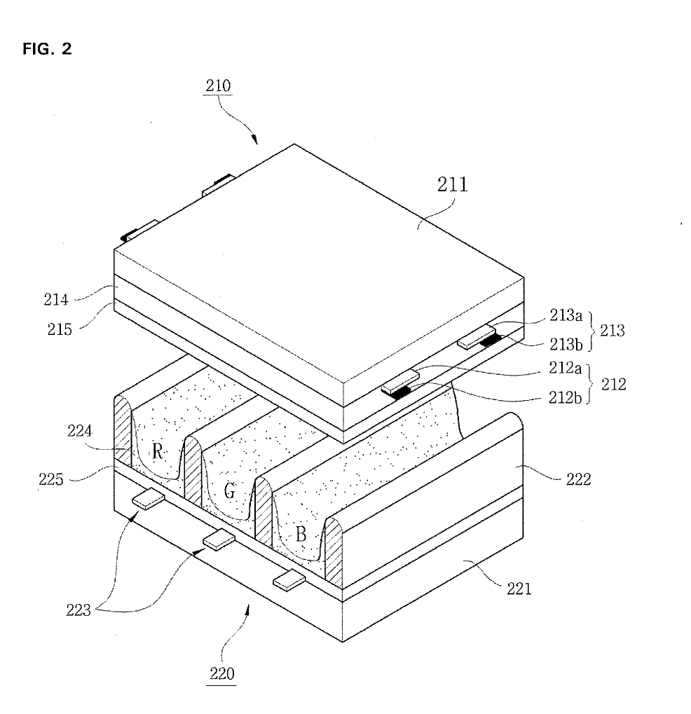

The following is a detailed description of the plasma display panel 200, with reference to FIG. 2.

FIG. 2 illustrates an example of the structure of a plasma display panel of the plasma display apparatus according to the embodiment.

As illustrated in FIG. 2, the plasma display panel comprises a front panel 210 and a rear panel 220 which are coupled in parallel to oppose to each other at a given distance therebetween. The front panel 210 comprises a front substrate 211 which is a display surface. The rear panel 220 comprises a rear substrate 221 constituting a rear surface. A plurality of scan electrodes 212 and a plurality of sustain electrodes 213 are formed in pairs on the front substrate 211, on which an image is displayed, to form a plurality of maintenance electrode pairs. A plurality of data electrodes 223 are arranged on the rear substrate 221 to intersect with the plurality of maintenance electrode pairs.

The scan electrode 212 and the sustain electrode 213 each comprise transparent electrodes 212a and 213a made of transparent indium-tin-oxide (ITO) material and bus electrodes 212b and 213b made of a metal material. The scan electrode 212 and the sustain electrode 213 generate a mutual discharge therebetween in one discharge cell and maintain light emissions of discharge cells. The scan electrode 212 and the sustain electrode 213 each may comprise the transparent electrodes 212a and 213a. Further, the scan electrode 212 and the sustain electrode 213 each may comprise the bus electrodes 212b and 213b. The scan electrode 212 and the sustain electrode 213 are covered with one or more upper dielectric layers 214 to limit a discharge current and to provide insulation between the maintenance electrode pairs. A protective layer 215 with a deposit of MgO is formed on an upper surface of the upper dielectric layer 214 to facilitate discharge conditions.

A plurality of stripe-type (or well-type) barrier ribs 222 are formed in parallel on the rear substrate 221 of the rear panel 220 to form a plurality of discharge spaces (i.e., a plurality of discharge cells). The plurality of data electrodes 223 for performing an address discharge to generate vacuum ultraviolet rays are arranged in parallel to the barrier ribs 222. An upper surface of the rear substrate 221 is coated with Red (R), green (G) and blue (B) phosphors 224 for emitting visible light for an image display when an address discharge is performed. A lower dielectric layer 225 is formed between the data electrodes 223 and the phosphors 224 to protect the data electrodes 223.

The front panel 210 and the rear panel 220 are coalesced by a sealing process such that the plasma display panel is formed. A driving circuit substrate (not illustrated), on which drivers for supplying driving voltages to the scan electrode 212, the sustain electrode 213 and the data electrode 223 are formed, are disposed on a rear surface of the plasma display panel.

Referring again to FIG. 1, the scan driver 110 may supply a rising signal and a falling signal to the scan electrodes Y1 to Yn during a reset period. The scan driver 110 may supply a sustain signal to the scan electrodes Y1 to Yn during a sustain period.

The scan driver 110 may supply scan signals to the scan electrodes Y1 to Yn during an address period using at least one scan type of a plurality of scan types which are different from one another in the order of supplying the scan signals to the plurality of scan electrodes. More specifically, the scan driver 110 supplies the scan signals to the scan electrodes Y1 to Yn using a first scan type in a first subfield of a frame, and supplies the scan signals to the scan electrodes Y1 to Yn using a second scan type, in which is different from the first scan type in the order of supplying the scan signals to the plurality of scan electrodes, in a second subfield of the frame.

The sustain driver 120 supplies a sustain signal to the sustain electrodes Z during the sustain period. The sustain driver 120 and the scan driver 110 alternately operate. Further, the sustain driver 120 supplies a bias signal of a positive polarity to the sustain electrodes Z during the address period.

The data driver 100, under the control of a timing controller (not illustrated), supplies a data signal to the data electrodes X1 to Xm. The data signal supplied to the data driver 100 corresponds to the scan signal supplied by the scan driver 110.

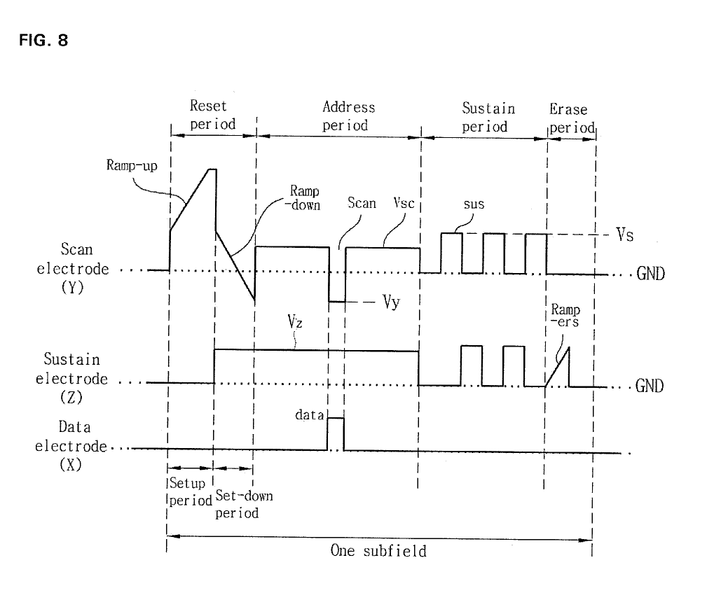

A function and an operation of the plasma display apparatus according to the embodiment will be described later with reference to FIG. 7 and the attached drawings subsequent to FIG. 7.

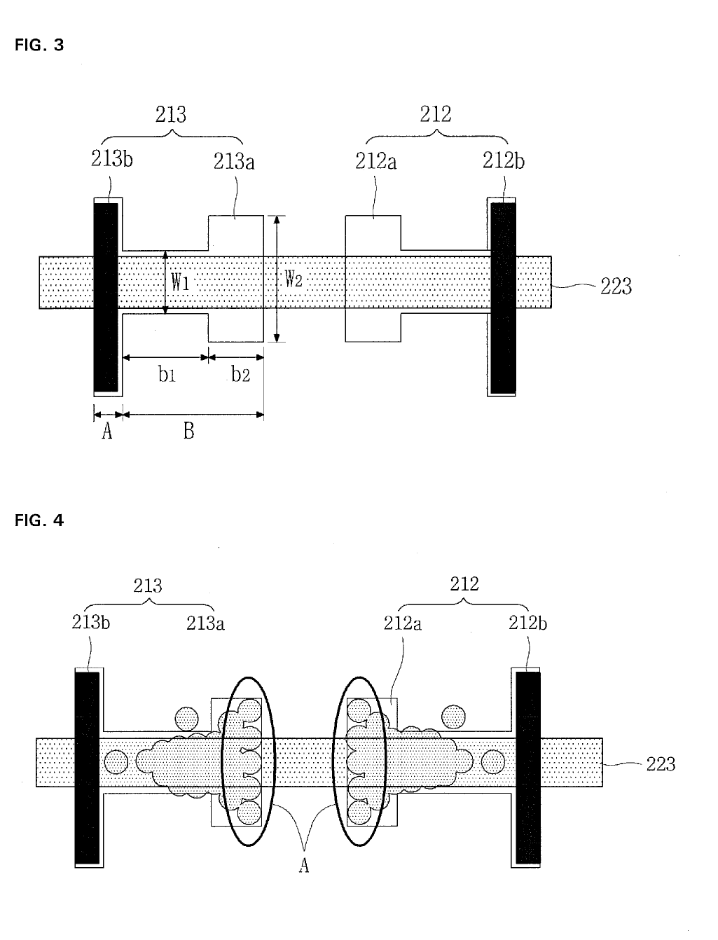

FIG. 3 illustrates the structure of electrodes formed inside a discharge cell according to the embodiment.

As illustrated in FIG. 3, the plasma display apparatus comprises the scan electrode 212 and the sustain electrode 213 for generating the mutual discharge therebetween in one discharge cell on the plasma display panel and maintaining light emissions of discharge cells. The scan electrode 212 and the sustain electrode 213 each comprise transparent electrodes 212a and 213a made of a transparent material and bus electrodes 212b and 213b made of a metal material.

The discharge cell is formed at a position where the scan electrode 212 and the sustain electrode 213 intersect the data electrode 223. FIG. 3 illustrates in detail the electrode structure inside one discharge cell. At least one of the scan electrode 212 and the sustain electrode 213 comprises a base A, and a projecting portion B. The base A is formed in a direction of each of the scan electrode 212 and the sustain electrode 213. The projecting portion B projects from the base A toward a central direction of the discharge cell. The projecting portion B comprises a first projecting area b1 and a second projecting area b2. A distance between the second projecting area b2 and the base A is more than a distance between the first projecting area b1 and the base A. The width of the second projecting area b2 is more than the width of the first projecting area b1.

Although the above description has been made with respect to a case where the transparent electrode 212a of the scan electrode 212 and the transparent electrode 213a of the sustain electrode 213 do not have the constant width, it is not limited thereto. It is possible to control the width of at least one of the transparent electrode and the bus electrode of each of the scan electrode and the sustain electrode.

The transparent electrodes 212a and 213a may have a T shape such that the widest width of the transparent electrode 212a corresponding to the projecting portion B is opposite to the widest width of the transparent electrode 213a corresponding to the projecting portion B.

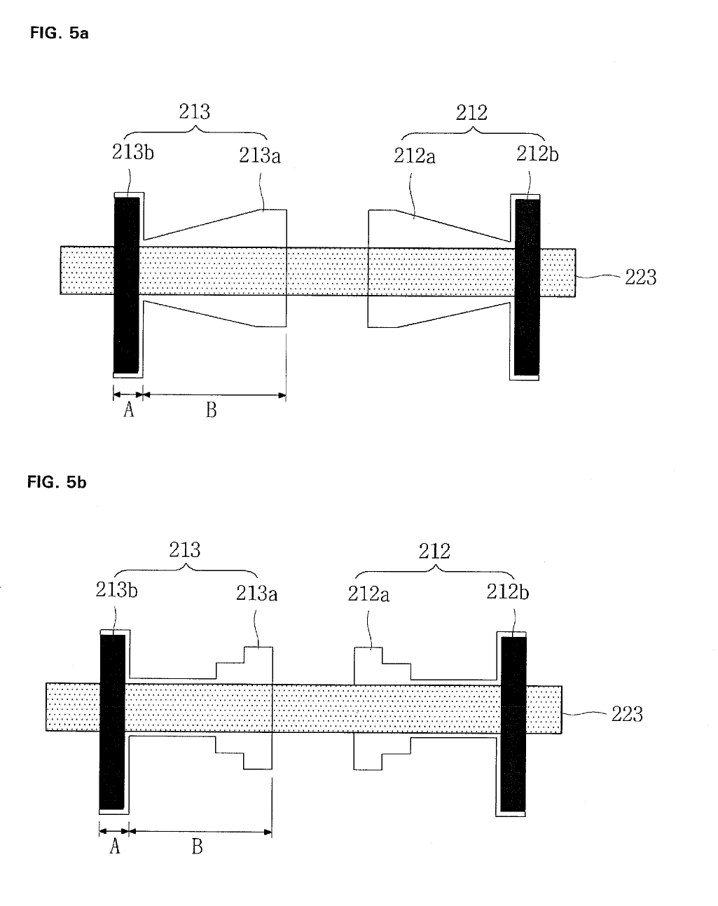

FIG. 4 illustrates wall charges distributed inside one discharge cell having the electrode structure of FIG. 3 when generating a discharge.

As illustrated in FIG. 4, when the scan electrode 212 and the sustain electrode 213 generate a discharge within one discharge cell, wall charges contributing to a discharge voltage are formed. The wall charges are intensively formed around a space between the transparent electrodes 212a and 213a in the central direction of the discharge cell. In other words, the wall charges are intensively formed in an area A indicated by an oval. The distribution of the wall charges is controlled depending on the width in a longitudinal direction of the scan electrode 212 and the sustain electrode 213.

When the wall charges are intensively formed around an opposite area of the transparent electrodes 212a and 213a, the discharge between the scan electrode 212 and the sustain electrode 213 easily occurs, thereby reducing a firing voltage. Accordingly, a driving voltage is lowered, thereby efficiently preventing a damage to a driver integrated circuit.

Further, the scan electrode 212 and the sustain electrode 213 accurately generate a sustain discharge for displaying an image, thereby improving the quality of the image displayed on the plasma display panel.

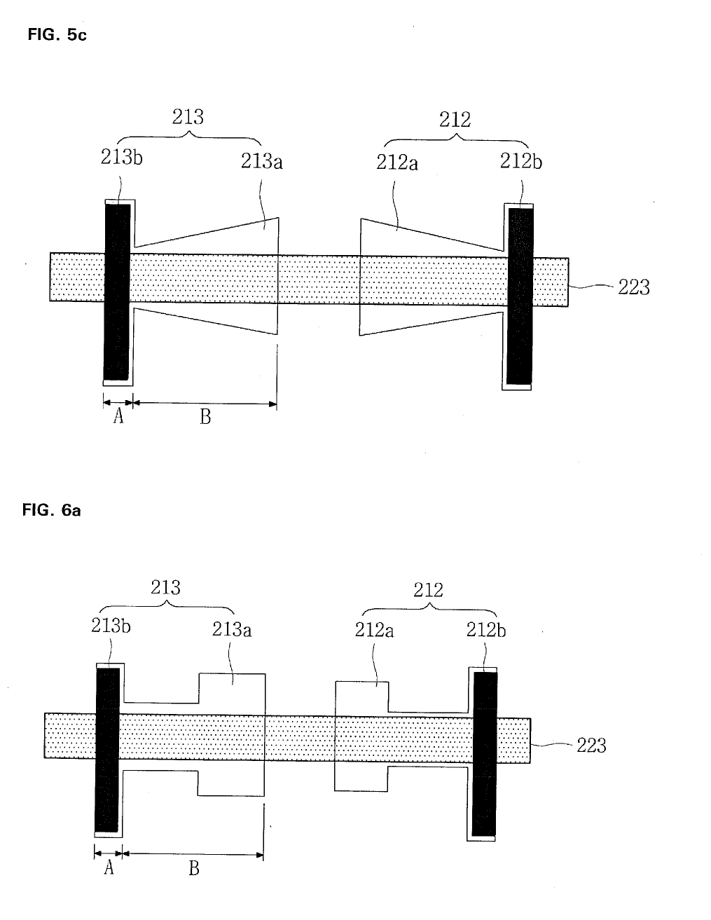

FIGS. 5a to 5c illustrate another structure of the electrode formed inside the discharge cell.

As illustrated in FIGS. 5a to 5c, the discharge cell is formed at a position where the scan electrode 212 and the sustain electrode 213 intersect the data electrode 223. At least one of the scan electrode 212 and the sustain electrode 213 comprises a base A, and a projecting portion B. The base A is formed in a direction of each of the scan electrode 212 and the sustain electrode 213. The projecting portion B projects from the base A toward a central direction of the discharge cell. The projecting portion B comprises a first projecting area b1 and a second projecting area b2. A distance between the second projecting area b2 and the base A is more than a distance between the first projecting area b1 and the base A. The width of the second projecting area b2 is more than the width of the first projecting area b1.

As illustrated in FIG. 5a, the width of the scan electrode 212 and the width of the sustain electrode 213 gradually widen toward the central direction of the discharge cell, and then are constant. In other words, the scan electrode 212 and the sustain electrode 213 may have a polygon shape.

As illustrated in FIG. 5b, the width of the scan electrode 212 and the width of the sustain electrode 213 increase stepwise toward the central direction of the discharge cell.

As illustrated in FIG. 5c, the width of the scan electrode 212 and the width of the sustain electrode 213 gradually widen toward the central direction of the discharge cell. In other words, the scan electrode 212 and the sustain electrode 213 may have a trapezoid shape.

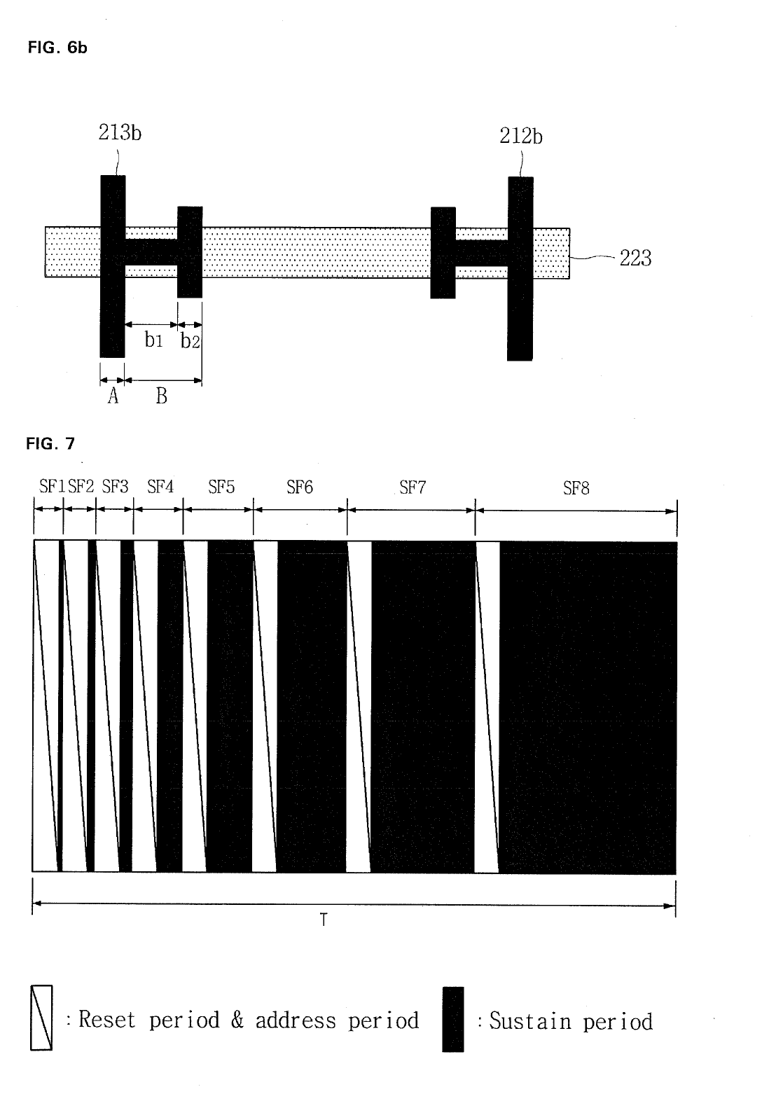

As described above, the electrode structure of the plasma display panel may variously change. Further, the scan electrode 212 and the sustain electrode 213 may have different areas. This will be described in detail in FIG. 6.

FIGS. 6a to 6c illustrate still another structure of the electrodes formed inside one discharge cell with respect to a difference in the areas of the electrodes.

As illustrated in FIG. 6a, the plasma display apparatus comprises the scan electrode 212 and the sustain electrode 213 for generating the mutual discharge therebetween in one discharge cell on the plasma display panel and maintaining light emissions of discharge cells. The scan electrode 212 and the sustain electrode 213 each comprise transparent electrodes 212a and 213a made of a transparent material and bus electrodes 212b and 213b made of a metal material.

The discharge cell is formed at a position where the scan electrode 212 and the sustain electrode 213 intersect the data electrode 223. The scan electrode 212 and the sustain electrode 213 in one discharge cell may have different areas. For example, the area of the scan electrode 212 may be more than the area of the sustain electrode 213. Further, an overlap area of the scan electrode 212 and the data electrode 223 may be more than an overlap area of the sustain electrode 213 and the data electrode 223.

By increasing the area of the scan electrode 212, a characteristic of an address discharge is improved. In other words, the address discharge accurately occurs between the scan electrode 212 and the data electrode 223.

Since the overlap area of the scan electrode 212 and the data electrode 223 is more than the overlap area of the sustain electrode 213 and the data electrode 223, the address discharge occurs easily. In other words, an increase in the area of the scan electrode 212 increases a formation space of the wall charges such that the address discharge occurs more accurately. The stable address discharge results in the generation of the more accurate sustain discharge between the scan electrode 212 and the sustain electrode 213

As a result, the plasma display apparatus according to the embodiment displays the image of high quality.

As illustrated in FIG. 6b, the plasma display apparatus comprises the scan electrode 212 and the sustain electrode 213 for generating the mutual discharge therebetween in one discharge cell on the plasma display panel and maintaining light emissions of discharge cells. The scan electrode 212 and the sustain electrode 213 each comprise bus electrodes 212b and 213b made of a metal material. Since the scan electrode 212 and the sustain electrode 213 each comprise the bus electrodes 212b and 213b without the transparent electrode, the manufacturing cost of the plasma display apparatus decreases. Further, the driving voltage is lowered using the bus electrode with a low resistance.

The discharge cell is formed at a position where the scan electrode 212 and the sustain electrode 213 intersect the data electrode 223. At least one of the scan electrode 212 and the sustain electrode 213 comprises a base A, and a projecting portion B. The base A is formed in a direction of the scan electrode 212 and the sustain electrode 213. The projecting portion B projects from the base A toward a central direction of the discharge cell. The projecting portion B comprises a first projecting area b1 and a second projecting area b2. A distance between the second projecting area b2 and the base A is more than a distance between the first projecting area b1 and the base A. The width of the second projecting area b2 in its longitudinal direction may be more than the width of the first projecting area b1 in its longitudinal direction.

As above, the width of the bus electrode 212b of the scan electrode 212 and the width of the bus electrode 213b of the sustain electrode 212 at a location corresponding to the inside of the discharge cell are controlled such that an electric field is diffused when generating a discharge, thereby increasing the discharge efficiency. For example, as illustrated in FIG. 6b, the bus electrodes 212b and 213b may have a T shape such that the widest width of the bus electrodes 212b is opposite to the widest width of the bus electrode 213b. Accordingly, a firing voltage can be lowered and a discharge can be diffused.

FIG. 7 illustrates an example of a method of driving the plasma display apparatus.

As illustrated in FIG. 7, a frame in the plasma display apparatus is divided into several subfields having a different number of emission times. Each of the subfields is subdivided into a reset period for initializing all the cells, an address period for selecting cells to be discharged, and a sustain period for representing gray level in accordance with the number of discharges.

For example, if an image with 256-level gray level is to be displayed, a frame period is divided into eight subfields SF1 to SF8. Each of the eight subfields SF1 to SF8 is subdivided into a reset period, an address period and a sustain period.

The sustain period determines gray level weight in each of the subfields. For example, gray level weight of a first subfield is set to 2⁰, and gray level weight of a second subfield is set to 2¹. In other words, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

The plasma display apparatus of the present invention uses a plurality of frames so as to display an image during 1 second. For example, 60 frames are used to display an image during 1 second. In such a case, the length of a frame is equal to 1/60 sec (i.e., 16.67 ms).

The explanation was given of an example of one frame comprising 8 subfields in FIG. 7. However, the number of subfields included in one frame may be variously changed. For example, one frame may comprise 12 subfields SF1 to SF12. Further, one frame may comprise 10 subfields SF1 to SF10.

Moreover, the subfields of one frame are arranged in increasing order of gray level weight in FIG. 7. However, the subfields may be arranged in decreasing order of gray level weight. Further, the subfields may be arranged irrespective of gray level weight.

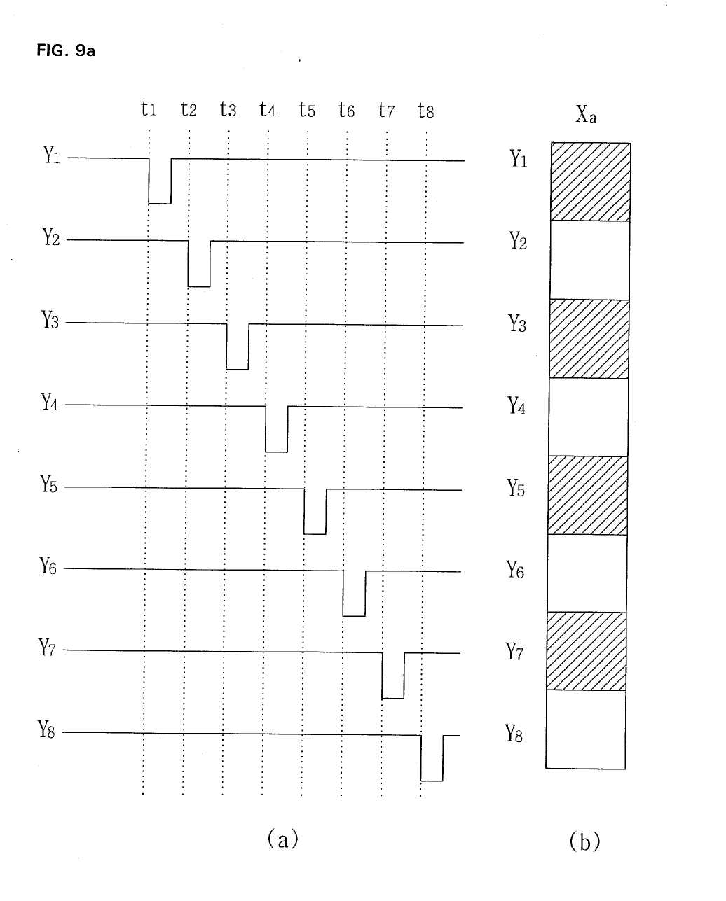

FIG. 8 illustrates an example of a driving waveform in accordance with the method of driving the plasma display apparatus.

In FIG. 8, a driving waveform generated in one subfield of the plurality of subfields constituting one frame is illustrated.

One subfield is divided into a reset period for initializing all cells, an address period for selecting cells to be discharged, and a sustain period for discharge maintenance of the selected cells.

The reset period is further divided into a setup period and a set-down period. During the setup period, a set-up signal (Ramp-up) with a high voltage is simultaneously supplied to all scan electrodes Y, thereby generating a weak dark discharge within the discharge cells of the whole screen. This results in wall charges being accumulated within the cells.

During the set-down period, a set-down signal (Ramp-down) is simultaneously supplied to the scan electrodes Y, thereby generating a weak erase discharge within the cells. Furthermore, the remaining wall charges are uniform inside the cells to the extent that the address discharge can be stably performed. The set-down signal (Ramp-down) may have a scan voltage (−Vy).

During the address period, a scan pulse (Scan) with the scan voltage (−Vy) is sequentially applied to the scan electrodes Y and, at the same time, a data signal (data) is selectively applied to the data electrodes X. As the voltage difference between the scan signal (Scan) and the data signal (data) is added to the wall voltage generated during the reset period, the address discharge occurs within the discharge cells to which the data pulse (data) is applied. Wall charges are formed inside the cells selected by performing the address discharge.

A positive voltage Vz is supplied to the sustain electrode Z during the set-down period and the address period so that an erroneous discharge does not occur between the sustain electrode Z and the scan electrode.

During the sustain period, a sustain signal (sus) is alternately supplied to the scan electrode Y and the sustain electrode Z such that a sustain discharge occurs.

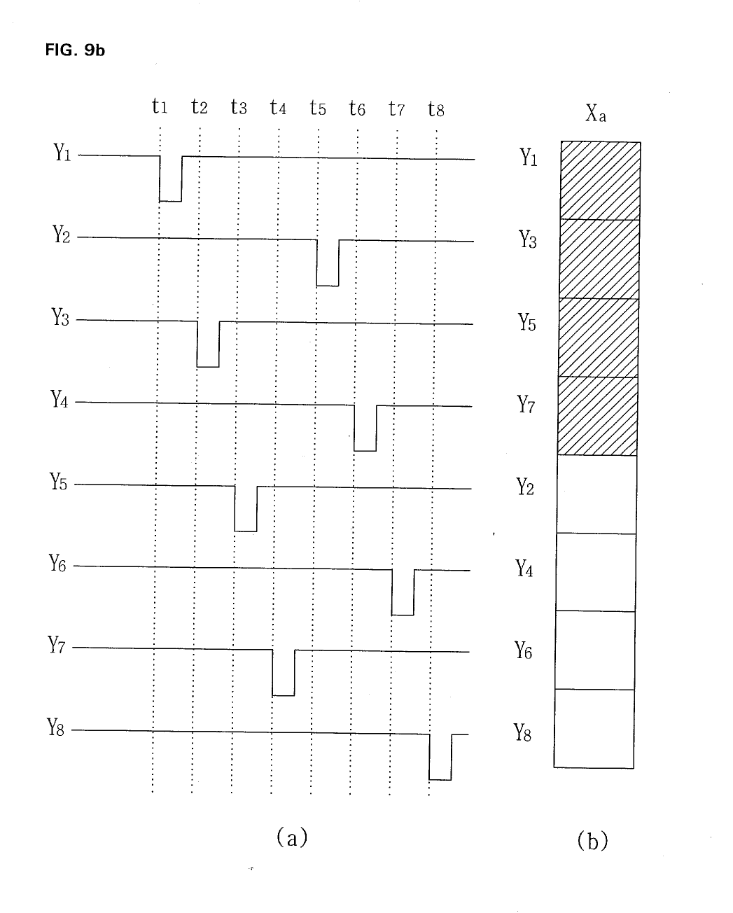

FIGS. 9a and 9b illustrate various scan types, which are different from one another in the order of supplying scan signals to a plurality of scan electrodes.

Referring to FIG. 9a, (a) illustrates a method for consecutively supplying the scan signals to the first scan electrode Y1 to the eighth scan electrode Y8. In this case, as illustrated in (b) of FIG. 9a, data with a repeating pattern of high and low voltage levels may be supplied. For example, a data signal with a high voltage level is supplied to a discharge cell located at an intersection of an Xa data electrode and the second scan electrode Y2, a discharge cell located at an intersection of the Xa data electrode and the fourth scan electrode Y4, a discharge cell located at an intersection of the Xa data electrode and the sixth scan electrode Y6, and a discharge cell located at an intersection of the Xa data electrode and the eighth scan electrode Y8. Further, a data signal with a low voltage level is supplied to discharge cells located at intersections of the Xa data electrode and the remaining first, third, fifth and seventh scan electrodes Y1, Y3, Y5 and Y7.

In this case, the data driver consecutively performs on/off switching operations in order to supply the data signals with the repeating pattern of the high and low voltage levels. Accordingly, the number of switching operations of the data driver increases, thereby increasing the generation of a displacement current. Due to this, the possibility of an electrical damage to the data driver increases. The number of switching operations of the data driver may be the number of changes in a voltage level of a data signal.

Next, referring to FIG, 9b, as compared to the case of FIG. 9a, there is a case where the scan signals are supplied to the first scan electrode Y1 to the eighth scan electrode Y8 in the scanning order different from the scanning order illustrated in FIG. 9a, and the data signal with the same pattern is supplied. For example, it is assumed that the scan signals are supplied to the first, third, fifth, seventh, second, fourth, sixth and eighth scan electrodes Y1, Y3, Y5, Y7, Y2, Y4, Y6, Y8 in the order named. That is, as compared to FIG. 9a, the pattern of data is the same, and the scanning order, i.e., the supply order of scan signals is different.

In this case, the data driver supplies a data signal with a high voltage level during the supplying of the scan signals to the first, third, fifth and seventh scan electrodes Y1, Y3, Y5 and Y7. The data driver supplies a data signal with a low voltage level during the supplying of the scan signals to the second, fourth, sixth and eighth electrodes Y2, Y4, Y6 and Y8.

In other words, when the scan signals are supplied to the first, second, third, fourth, fifth, sixth, seventh and eighth scan electrodes Y1, Y2, Y3, Y4, Y5, Y6, Y7, Y8 in the order named as illustrated in FIG. 9a, the data driver performs a total of seven times of switching operations. On the other hand, when the scan signals are supplied to the first, third, fifth, seventh, second, fourth, sixth, and eighth scan electrodes Y1, Y3, Y5, Y7, Y2, Y4, Y6, Y8 in the order named as illustrated in FIG. 9b, the data driver performs only a total of one time of switching operation. Accordingly, a magnitude of the displacement current generated in the data driver in FIG. 9b is reduced, thereby preventing the electrical damage to the data driver.

Although a scanning type has been so far applied in consideration of only the number of changes in a voltage level of a data signal supplied to one data electrode, it is possible to apply a scan type in consideration of the difference in voltage levels of data signals supplied to two or more adjacent data electrodes.

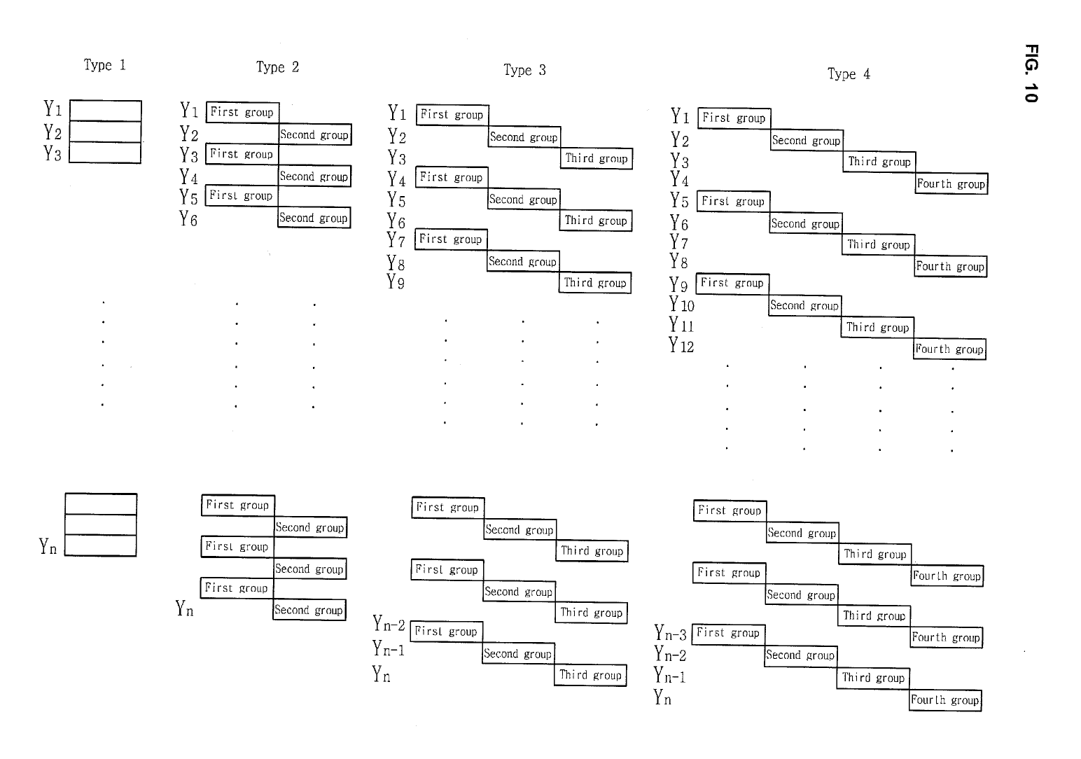

FIG. 10 illustrates a plurality of scan types, which are different from one other in the order of supplying scan signals to the plurality of scan electrodes.

Referring to FIG. 10, during the address, scan signals may be supplied to the plurality of scan electrodes using a plurality of scan types which are different from one another in the order of supplying the scan signals to the plurality of scan electrodes.

For example, scanning may be performed, i.e., scan signals may be supplied to the scan electrodes, using at least one scan type among a total of four scan types, e.g., a first type Type 1, a second type Type 2, a third type Type 3, and a fourth type Type 4.

The first scan type Type 1 is a scan type for supplying scan signals in the order of arrangement of the scan electrodes like the first, second, third, . . . scan electrodes Y1, Y2, Y3, . . . .

The second scan type Type 2 is a scan type for consecutively supplying scan signals to odd-numbered scan electrodes and then for consecutively supplying scan signals to even-numbered scan electrodes. For example, the second scan type Type 2 is a scan type for supplying scan signals in the order of the first, third, fifth, . . . , (n-1)-th scan electrodes Y1, Y3, Y5, . . . , (Yn-1), and for supplying scan signals in the order of the second, fourth, sixth, . . . , n-th scan electrodes Y2, Y4, Y6, . . . . Yn. The first, third, fifth, . . . , n-1)-th scan electrodes Y1, Y3, Y5, . . . . (Yn-1) are grouped into the scan electrodes of a first group, and the second, fourth, sixth, . . . , n-th scan electrodes Y2, Y4, Y6, . . . . Yn are grouped into the scan electrodes of a second group.

The third scan type Type 3 is a scan type for consecutively supplying scan signals to triple-numbered scan electrodes, i.e., for consecutively supplying scan signals to 3a-th scan electrodes, or for consecutively supplying scan signals to (3a+1)-th scan electrodes, or for consecutively supplying scan signals to (3a+2)-th scan electrodes, wherein a is an integer greater than 0. For example, the third scan type Type 3 is a scan type for supplying scan signals in the order of the first, fourth, seventh, . . . , (n-2)-th scan electrodes Y1, Y4, Y7, . . . , (Yn-2), for supplying scan signals in the order of the second, fifth, eighth, . . . , (n-1)-th scan electrodes Y2, Y5, Y8, . . . . (Yn-1), and for supplying scan signals in the order of the third, sixth, ninth, . . . , n-th scan electrodes Y3, Y6, Y9, . . . , Yn. The first, fourth, seventh, . . . , (n-2)-th scan electrodes Y1, Y4, Y7, . . . . (Yn-2) are grouped into the scan electrodes of a first group, the second, fifth, eighth, . . . . (n-1)-th scan electrodes Y2, Y5, Y8, . . . , (Yn-1) are grouped into the scan electrodes of a second group, and the third, sixth, ninth, . . . , n-th scan electrodes Y3, Y6, Y9, . . . , Yn are grouped into the scan electrodes of a third group.

The fourth scan type Type 4 is a scan type for consecutively supplying scan signals to quadruple-numbered scan electrodes, i.e., for consecutively supplying scan signals to 4b-th scan electrodes, or for consecutively supplying scan signals to (4b+1)-th scan electrodes, or for consecutively supplying scan signals to (4b+2)-th scan electrodes, or consecutively supplies scan signals to (4b+3)-th scan electrodes, wherein b is an integer greater than 0. For example, the fourth scan type Type 4 is a scan type for supplying scan signals in the order of the first, fifth, ninth, . . . , (n-3)-th scan electrodes Y1, Y5, Y9, . . . , (Yn-3), for supplying scan signals in the order of the second, sixth, tenth, . . . , (n-2)-th scan electrodes Y2, Y6, Y10, . . . , (Yn-2), for supplying scan signals in the order of the third, seventh, eleventh, . . . , (n-1l)-th scan electrodes Y3, Y7, Y11, . . . , Yn-1, and for supplying scan signals in the order of the fourth, eighth, twelfth, . . . , n-th scan electrodes Y4, Y8, Y12, . . . , Yn. The first, fifth, ninth, . . . , (n-3)-th scan electrodes Y1, Y5, Y9, . . . . (Yn-3) are grouped into the scan electrodes of a first group, the second, sixth, tenth, . . . , (n-2)-th scan electrodes Y2, Y6, Y10, . . . , (Yn-2) are grouped into the scan electrodes of a second group, the third, seventh, eleventh, . . . , (n-1)-th scan electrodes Y3, Y7, Y11, . . . , Yn-1 are grouped into the scan electrodes of a third group, and the fourth, eighth, twelfth, . . . , n-th scan electrodes Y4, Y8, Y12, . . . , Yn are grouped into the scan electrodes of a fourth group.

For example, when the number of switching operations of the data driver with respect to the first scan type in the first subfield is less than the number of switching operations of the data driver with respect to the second scan type in the first subfield, the scan signals are supplied to the plurality of scan electrodes using the first scan type Type 1 in the first subfield.

On the contrary, when the number of switching operations of the data driver with respect to the second scan type in the second subfield is less than the number of switching operations of the data driver with respect to the first scan type in the second subfield, the scan signals are supplied to the plurality of scan electrodes using the second scan type Type 2 in the second subfield.

As above, different scan types may be supplied in different subfields.

As explained above, a distance between the scan electrodes belonging to one group to which scan signals are consecutively supplied may be kept substantially equal. For example, in the third type Type 3, among the first, fourth, and seventh scan electrodes Y1, Y4, and Y7 supplied with scan signals in the consecutive order, a distance between the first scan electrode Y1 and the fourth scan electrode Y4 is substantially equal to a distance between the fourth scan electrode Y4 and the seventh scan electrode Y7.

On the contrary, a distance between the scan electrodes belonging to one group to which scan signals are consecutively supplied may be set different from each other. For example, scan signals are consecutively supplied to the first scan electrode Y1, the second scan electrode Y2, and the seventh scan electrode Y7. A distance between the first scan electrode Y1 and the second scan electrode Y2 is different from a distance between the second scan electrode Y2 and the seventh scan electrode Y7.

Although FIG. 10 has illustrated and described a total of four scan types and the method for selecting at least one of the four scan types and supplying scan signals to scan electrodes Y in the order corresponding to the selected scan type, it is possible to provide various numbers of scan types such as two scan types, three scan types, and five scan types, and use the method for selecting at least one of these scan types and supplying scan signals to the scan electrodes Y in an order corresponding to the selected scan type.

As above, when scan signals are supplied to the scan electrodes using the plurality of scan types, the scan signals are supplied to the scan electrodes using one scan type, in which the number of switching operations of the data driver in response to a pattern of input image data is the least.

Alternatively, scan signals can be supplied to scan electrodes using at least one of the plurality of scan types in which the number of switching operations of the data driver in response to a pattern of input image data is equal to or less than a threshold value. Here, the magnitude of the threshold value can be determined within a range of sufficiently protecting the data driver from an electrical damage.

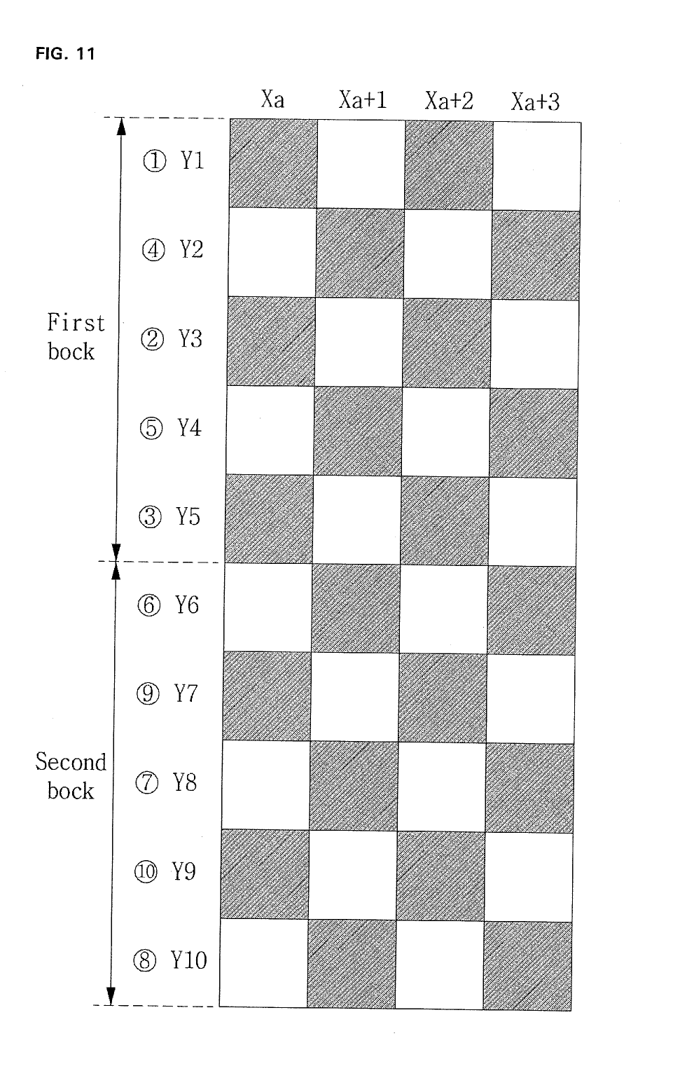

FIG. 11 illustrates one example of a method for determining a scan type by block.

Referring to FIG. 11, in a first block comprising the first scan electrode Yl to the fifth scan electrode Y5, scan signals are consecutively supplied in the order of the first, third, fifth, second, and fourth scan electrodes Y1, Y3, Y5, Y2, and Y4 as shown in the second type Type 2 of FIG. 10. Further, in a second block comprising the sixth scan electrode Y6 to the tenth scan electrode Y10, scan signals are consecutively supplied in the order of the sixth, eighth, tenth, seventh, and ninth scan electrodes Y6, Y8, Y10, Y7, and Y9 as shown in the second type Type 2 of FIG. 10. Likewise, scan types may be set, respectively, for each block comprising one or more scan electrodes.

Although the number of scan electrodes belonging to each block has been set to be equal in the above, it is possible to set the number of scan electrodes belonging to at least one block different from the number of scan electrodes belonging to other blocks. For example, the first block may comprise 10 scan electrodes, while the second block may comprise 100 scan electrodes.

Further, although the above description has been made with respect to a case where the scan type supplied to each block is the same, the scan type supplied to at least one block may be different from the scan type supplied to other blocks. For example, the third type Type 3 of FIG. 10 may be applied to the first block, and the fourth type Type 4 of FIG. 10 may be applied to the second block.

Moreover, when different scan types are applied to each block, the scan signals are supplied to the scan electrodes using one scan type, in which the number of switching operations of the data driver in response to a pattern of input image data for each block is the least.

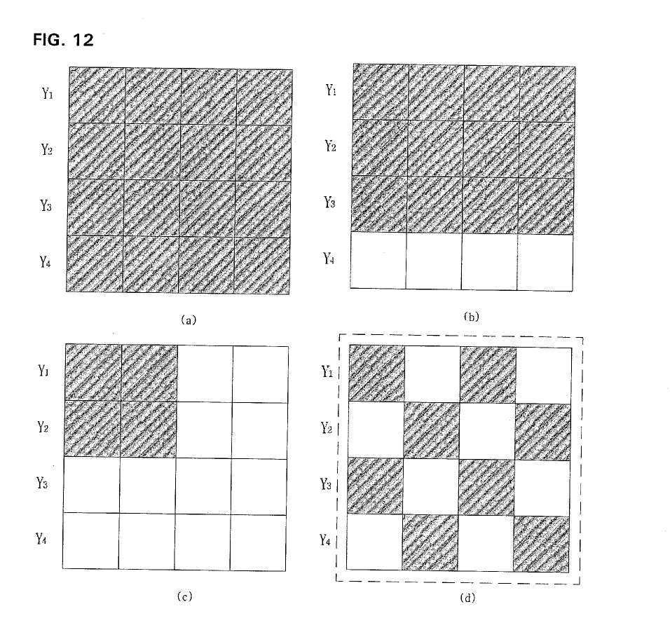

FIG. 12 illustrates another example of a method for determining a scan type relative to a threshold value of the number of switching operations of the data driver.

Referring to FIG. 12, when the number of switching operations of the data driver in response to a pattern of input image data is equal to or more than a threshold voltage, the scan type may be changed.

For example, (a) illustrates a case where a data signal having a high voltage level is supplied to the discharge cells arranged on all the scan electrodes Y1 to Y4. (b) illustrates a case where a data signal having a high voltage level is supplied to the discharge cells arranged on the first, second, and third scan electrodes Y1, Y2, and Y3, and a data signal having a low voltage level is supplied to the discharge cell arranged on the fourth scan electrode Y4. (c) illustrates a case where a data signal having a high voltage level is supplied to the discharge cells arranged on the first and second scan electrodes Y1 and Y2, and a data signal having a low voltage level is supplied to the discharge cells arranged on the third and fourth scan electrodes Y3 and Y4. (d) illustrates a case where a data signal having a high voltage level is supplied to every other discharge cell.

In the case of (a), the total number of switching operations of the data driver is 0 because there occurs no change in a voltage level of a data signal. In the case of (b), the total number of switching operations of the data driver is equal to 4 because the voltage level of the data signal is changed a total of four times. In the case of (c), the total number of switching operations of the data driver is 2. In the case of (d), the total number of switching operations of the data driver is 12. Assuming that a total of 10 times of switching operations is a threshold value, only the image data of the last (d) pattern among image data of the (a), (b), (c), and (d) patterns may cause the number of switching operations to be greater than the threshold value.

As above, when the number of switching operations is equal to or more than the threshold value, this indicates that an electrical damage may be exerted on the data driver. Therefore, in case of image data of the (a), (b), and (c) patterns, the scan signals are supplied in the order of the first, second, third, and fourth scan electrodes Y1, Y2, Y3, and Y4. In case of image data of the (d) pattern, as shown in the second type Type 2 of FIG. 10, scan signals are supplied in the order of the first, third, second, and fourth scan electrodes Y1, Y3, Y2, and Y4. In this way, it is possible to change the scan type only in the case of image data of a specific pattern.

As above, when the number of switching operations of the data driver in response to a pattern of input image data with respect to the first scan type Type 1 for sequentially supplying scan signals to the plurality of scan electrodes is equal to or less than the threshold value, the scan signals are supplied to the scan electrodes using the first scan type Type 1. On the other hand, when the number of switching operations of the data driver in response to a pattern of input image data with respect to the first scan type Type 1 is greater than the threshold value, scan signals are supplied to the scan electrodes using the second scan type Type 2 which is different from the first scan type Type 1.

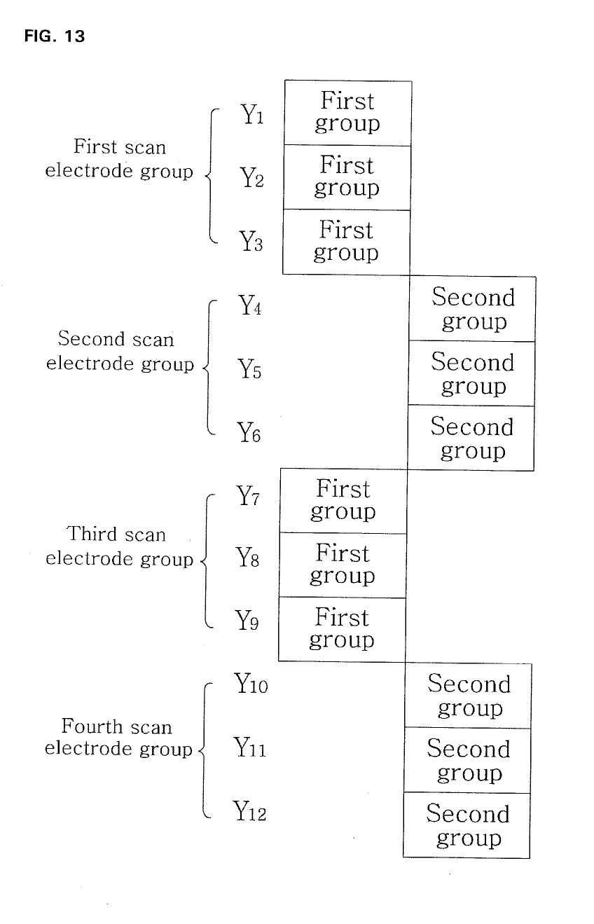

FIG. 13 illustrates another example of a method for supplying scan signals to the plurality of scan electrodes using a plurality of scan types which are different from one other in the order of supplying the scan signals to the scan electrodes.

Referring to FIG. 13, although the above description has been made with respect to a case where scan signals are supplied to the scan electrodes Y using a scan type having a scan order corresponding to each scan electrode Y, it is possible to divide the plurality of scan electrodes into a plurality of scan electrode groups and supply scan signals to the plurality of scan electrode groups.

For example, the first, second, and third scan electrodes Y1, Y2, and Y3 are set to the first scan electrode group, the fourth, fifth, and sixth scan electrodes Y4, Y5, and Y6 are set to the second scan electrode group, the seventh, eighth, and ninth scan electrodes Y7, Y8, and Y9 are set to the third scan electrode group, and the tenth, eleventh, and twelfth scan electrodes Y10, Y11, and Y12 are set to the fourth scan electrode group. Although in FIG. 13, each scan electrode group is set to comprise three scan electrodes, it is possible to variously change the number of scan electrodes to 2, 4, 5, etc.

Also, it is possible to set at least one of the plurality of scan electrode groups so as to comprise a different number of scan electrodes Y from the other scan electrode groups.

As above, in the case that the scan electrode groups are set, if the second type Type 2 of FIG. 10 is applied, scan signals are consecutively supplied to the scan electrodes belonging to the first scan electrode group, i.e., the first, second, and third scan electrodes Y1, Y2, and Y3, then scan signals are consecutively supplied to the scan electrodes belonging to the third scan electrode group, i.e., the seventh, eighth, and ninth scan electrodes Y7, Y8, and Y9, then scan signals are consecutively supplied to the scan electrodes belonging to the second scan electrode group, i.e, the fourth, fifth, and sixth scan electrodes Y4, Y5, and Y6, and then scan signals are consecutively supplied to the scan electrodes belonging to the fourth scan electrode group, i.e., the tenth, eleventh, and twelfth scan electrodes Y10, Y11, and Y12.

As above, it is possible to apply a scan type for consecutively supplying scan signals to at least one scan electrode belonging to at least one of the plurality of scan electrode groups.

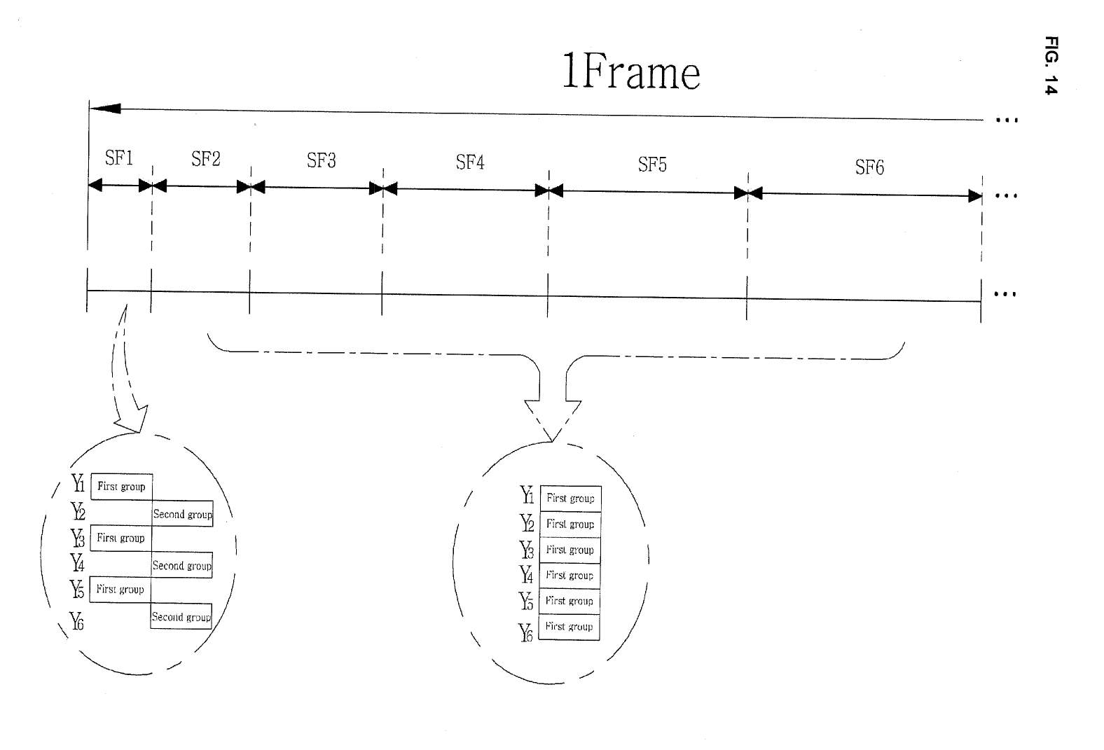

FIG. 14 illustrates one example of a method for determining a scan type in consideration of a subfield.

Referring to FIG. 14, the order of supplying the scan signals to the plurality of scan electrodes in at least one subfield of a frame may be different from the order of supplying the scan signals to the plurality of scan electrodes in other subfields. In other words, it is possible to determine the scan type in consideration of a subfield. For example, the second type Type 2 of FIG. 10 is used in the first subfield SF1 and the first type Type 1 of FIG. 10 is used in the remaining subfields such that the displacement is minimized.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plurality of scan electrodes;
a plurality of sustain electrodes formed in parallel to the plurality of scan electrodes;
a plurality of data electrodes formed to intersect the plurality of scan electrodes and the plurality of sustain electrodes;
a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame; and
a data driver for supplying a data signal corresponding to the scan signals to the plurality of data electrodes during an address period,
wherein the scan electrode or the sustain electrode comprises a base and a projecting portion at a location corresponding to the inside of the discharge cell,
the base is formed in a direction of the scan electrode and the sustain electrode, and the projecting portion projects from the base toward a central direction of the discharge cell and comprises a first projecting area and a second projecting area, and
a distance between the second projecting area and the base is more than a distance between the first projecting area and the base, and the width of the second projecting area is more than the width of the first projecting area.

2. The plasma display apparatus of claim 1, wherein the number of times of switching of the data driver with respect to the first scan type in the first subfield is less than the number of times of switching of the data driver with respect to the second type in the first subfield.

3. The plasma display apparatus of claim 2, wherein the number of switching operations of the data driver equals the number of changes in a voltage level of the data signal.

4. The plasma display apparatus of claim 1, wherein at least one of the first scan type and the second scan type comprises a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

5. The plasma display apparatus of claim 1, wherein the plurality of scan electrodes comprise a first scan electrode, a second scan electrode, and a third scan electrode, adjacent to one another, to which the scan signals are supplied in a consecutive order, and
a distance between the first scan electrode and the second scan electrode is substantially equal to a distance between the second scan electrode and the third scan electrode.

6. The plasma display apparatus of claim 1, wherein the scan driver supplies the scan signals to the scan electrodes using one of the first scan type and the second scan type, in which the number of times of switching of the data driver is less than the other, in response to a pattern of image data input for each subfield of the frame.

7. The plasma display apparatus of claim 1, wherein at least one of the first scan type and the second scan type comprises a scan type for consecutively supplying the scan signals to the scan electrodes of one scan electrode group.

8. The plasma display apparatus of claim 1, wherein the scan driver supplies the scan signals to the plurality of scan electrodes using at least one of the first scan type and the second scan type, in which the number of switching operations of the data driver in response to a pattern of input image data is equal to or less than a threshold value.

9. The plasma display apparatus of claim 1, wherein when the number of switching operations of the data driver with respect to the first scan type in response to a pattern of input image data is equal to or more than a threshold value, the scan driver supplies the scan signals to the scan electrodes using the second scan type.

10. The plasma display apparatus of claim 1, wherein the first scan type comprises a scan type for consecutively supplying the scan signals to the plurality of scan electrodes, and
the scan driver supplies the scan signals to the scan electrodes using the first scan type when the number of switching operations of the data driver with respect to the first scan type in response to a pattern of input image data is equal to or less than a threshold value, and the scan driver supplies the scan signals to the scan electrodes using the second scan type when the number of switching operations of the data driver with respect to the first scan type in response to a pattern of input image data is equal to or more than the threshold value.

11. The plasma display apparatus of claim 1, wherein the width of at least one of the scan electrode or the sustain electrode in the direction of the scan electrode or the sustain electrode gradually widens toward the central direction of the discharge cell.

12. The plasma display apparatus of claim 1, wherein the width of at least one of the scan electrode or the sustain electrode in the direction of the scan electrode or the sustain electrode increases stepwise toward the central direction of the discharge cell.

13. The plasma display apparatus of claim 1, wherein at least one of the scan electrode or the sustain electrode has a T shape.

14. The plasma display apparatus of claim 1, wherein at least one of the scan electrode or the sustain electrode has a trapezoid shape.

15. The plasma display apparatus of claim 1, wherein the area of the scan electrode is more than the area of the sustain electrode.

16. The plasma display apparatus of claim 1, wherein the overlap area of the scan electrode and the data electrode is more than the overlap area of the sustain electrode and the data electrode at a location corresponding to the inside of the discharge cell.

17. A method of driving a plasma display apparatus comprising a plurality of scan electrodes, a plurality of sustain electrodes, and a plurality of data electrodes formed to intersect the plurality of scan electrodes and the plurality of sustain electrodes, the method comprising:
supplying scan signals to the plurality of scan electrodes using a first scan type in a first subfield of a frame;
supplying the scan signals to the plurality of scan electrodes using a second scan type, which is different from the first scan type in an order of supplying the scan signals, in a second subfield of the frame; and
supplying a data signal corresponding to the scan signals to the plurality of data electrodes during an address period,
wherein the scan electrode or the sustain electrode comprises a base and a projecting portion at a location corresponding to the inside of the discharge cell,
the base is formed in a direction of the scan electrode and the sustain electrode, and the projecting portion projects from the base toward a central direction of the discharge cell and comprises a first projecting area and a second projecting area, and
a distance between the second projecting area and the base is more than a distance between the first projecting area and the base, and the width of the second projecting area is more than the width of the first projecting area.

18. The method of claim 17, wherein the number of times of switching of the data driver with respect to the first scan type in the first subfield is less than the number of times of switching of the data driver with respect to the second type in the first subfield.

19. The method of claim 18, wherein the number of switching operations of the data driver equals the number of changes in a voltage level of the data signal.

20. The method of claim 17, wherein the first scan type is a scan type for consecutively supplying the scan signals to the plurality of scan electrodes, and
the scan driver supplies the scan signals to the scan electrodes using the first scan type when the number of switching operations of the data driver with respect to the first scan type in response to a pattern of input image data is equal to or less than a threshold value, and the scan driver supplies the scan signals to the scan electrodes using the second scan type when the number of switching operations of the data driver with respect to the first scan type in response to a pattern of input image data is equal to or more than a threshold value.
